(19) United States
(12) Patent Application Publication
(10) Pub. No.: US 2020/0063002 A1
(43) Pub. Date: Feb. 27, 2020

(54) Plasticized Cellulosic Lacquer Sealant for Microscope Slides and Related Methods

(71) Applicant: Hempstead Halide, Inc., Galveston, TX (US)

(72) Inventors: Thomas E. Hays, Galveston, TX (US); Tristan M. F. Hays, Galveston, TX (US)

(21) Appl. No.: 16/110,465

(22) Filed: Aug. 23, 2018

(51) Int. Cl. C09J 101/18; C09J 11/06; G02B 21/34

(52) U.S. Cl. CPC C09J 101/18; C08K 5/21; G02B 21/34; C09J 11/06

(57) ABSTRACT

Disclosed is a ringing sealant defined by the addition of ethyl centralite to a solution of cellulose nitrate dissolved in acetone. Suitably, the preferred embodiment of the ringing sealant for microscope slides features a degree of elasticity sufficient to prevent that mixture from cracking a cover glass as the mixture dries or when dried.

The inventors of the subject matter disclosed in this document are: Tristan M. F. Hays of Galveston Texas, U.S.A; and Thomas E. Hays of Galveston, Texas, U.S.A.

### CROSS-REFERENCE TO RELATED APPLICATIONS

Not applicable.

### CROSS-REFERENCE TO RELATED APPLICATIONS STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter relates generally to the field of microscopy and preparing microscope slides. The disclosed subject matter is in the specific field of ringing sealants for the cover glasses or slips of microscope slides and related methods. More specifically, this invention concerns a plasticized cellulosic lacquer in an acetone base for use as a ringing sealant for the cover glasses/slips of microscope slides.

Background of the Invention

A microscope is an important tool that allows the viewing or visual inspection of objects that are otherwise too small to be seen by a naked eye. In a typical mode of use, a specimen to be viewed is mounted on a “microscope slide” and placed under a series of lenses so that the specimen is magnified for viewing through the microscope. Usually, the slide is defined by a thin sheet of glass or similar inert transparent material with or without surface depressions used as a base compatible with the stage of a microscope upon which a specimen may be place for observation through the microscope. Typically, a light source is provided under and shown through the microscope slide to assist in viewing or observation of the magnified specimen.

FIG. 1 is an exploded view of a typical microscope slide 1000 for observing a specimen 2000. As shown in the figure, it is a common practice (e.g., in the field of microscopy and related fields including but not limited to entomology, histology and the like), when mounting a specimen 2000 to be examined upon a glass microscope slide 1000 to cover the mounted specimen with a thin flat cover of transparent glass, called a “cover glass” or “cover slip” 3000.

FIG. 2 is a diagram for loading a microscope slide 1000 with a specimen 2000. In a typical slide-loading process: (A.) a specimen 2000 may be placed on the slide 1000; (B.) the specimen 2000 may be provided and adjusted to the center of the slide 1000; (C.) the glass cover 3000 may be placed over both of the specimen 2100 (typically at a tilted approach so that face of the cover 3000 engages the specimen 2000); and (D) the glass cover 3000 is lowered over the specimen in a way that prevents the trapping of air-bubbles at the interface of the cover 3000 and specimen.

Still referring to FIG. 2 and as shown in step D, the cover glass 3000 is often configured with a footprint of a greater or equal width or diameter than the footprint of the specimen 2000 over which it is to be placed. Additionally, the footprint of the cover glass 3000 is usually configured to be less or equal width or diameter than the plan or surface area of the underlying microscope slide. The result of these dimensional differences is a gap between the exposed outer edge of the covering glass slip 3000 and the underlying surface of the microscope slide 100 because the cover 3000 is lifted by the specimen 2000. This gap is spaced from the underlying glass microscope slide 1000 by a distance approximately equal to the thickness of the mounted specimen 2000.

FIGS. 3A and 3B are illustrations of a process of a gap-filling process or action called “ringing.” It is common to fill the gap between the cover 3000 and the slide 1000 with a seal to protect the specimen 2000 from contamination (e.g., so as to exclude the ingress of moisture, microbes and other contaminants). Often, the seal is a liquid sealant 4000, e.g., applied by dropper (FIG. 3B) or wipe (FIG. 3A) and placed in all the gaps around the specimen, which is an action known in the art as “ringing.” Suitably, the liquid sealant 4000 is applied in an amount sufficient to fill the vertical space between the microscope slide 1000 and the cover glass 3000 and to do so around the entire periphery of the cover glass 3000.

Because viewability of the specimen through the slide is of paramount concern, it is desirable that the liquid sealant used in the ringing process be transparent. Transparent sealants do not to cast a shadow upon the mounted specimen. Also, the liquid sealant should have a viscosity low enough and capillarity high enough that the applied sealant will flow into the entire gap or space between the cover glass and the microscope slide by capillary action. Adherent properties are also a concern since it is desirable that the applied sealant should bond to both the cover glass and the underlying microscope slide and in so doing render the cover glass immobile relative to the mounted specimen and the underlying microscope slide. Finally, it is desirable that the applied sealant should dry quickly and completely after application and in doing so form a solid moisture proof barrier between the specimen or the medium in which the specimen is mounted and the external environment.

It is known in the art that a cellulose nitrate lacquer made with an acetone solvent base has these desirable qualities when used as a ringing sealant for the preparation of microscope slides. However, this known ringing sealant is not entirely satisfactory for all applications. One problem is that the strong and ridged bond formed by a cellulose nitrate lacquer used as a ringing sealant constricts such that the cover slide is pulled taut over the specimen with too much tension or stress. The excessive tension/stress on the cover glass is sufficient to crack the cover glass. Cracked cover glass is problematic because: (i) cracks allow the ingress of moisture, microbes and other contaminants into contact with the mounted specimen and the mounting medium beneath the cover glass; (ii) cracks and contaminants potentially obscure the view of the specimen when viewed through a microscope; or (iii) cracks and contaminants can destroy the specimen through biological or chemical action or a combination of both.

### LISTING OF PRIOR ART

The use of cellulose nitrate lacquer in an acetone base as a ringing sealant is known in the art concerning microscopy.
See http://micro.sci-toys.com/permanent_slides;
see also http://www.microscopy-uk.org.uk/mag/indexmag.html?http://www.microscopy-uk.org.uk/mag/artaug02/wdnailpolish.html,

The use of ethyl centralite as a plasticizing agent for cellulose nitrate is known in the art concerning explosives and propellants. See U.S. Pat. No. 3,638,698A (Woodman 1966), U.S. Pat. No. 5,616,883A (Hamilton, 1994).

### SUMMARY OF THE INVENTION

In view of the foregoing, an object of this specification is to disclose a ringing sealant and related methodologies of preparing microscope slides without the drawbacks of known ringing sealants. It is a further objective to describe a ringing sealant that is transparent and that has a viscosity low enough and capillarity high enough that the applied sealant will flow into the entire gap or space between the cover glass and the microscope slide by capillary action. It is yet a further objective of this document to describe a ringing sealant with adherent properties for bonding cover glass to a slide in a way that renders the cover glass immobile relative to the mounted specimen and the underlying microscope slide. Finally, it is an objective of this disclosure to disclose a ringing sealant that dries quickly and completely after application to form a solid moisture proof barrier between (a) the specimen or the medium in which the specimen is mounted and (b) the external environment, without cracking the cover glass.

In a preferred embodiment, the disclosed subject matter is a ringing sealant defined by the addition of ethyl centralite to a solution of cellulose nitrate dissolved in acetone. Suitably, the preferred embodiment of the ringing sealant for microscope slides features a degree of elasticity sufficient to prevent that mixture from cracking a cover glass as the mixture dries or when dried.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is an exploded view of a typical microscope slide 1000, specimen, 2000, and cover glass 3000; and,

FIG. 2 is a flow chart illustrating the typical loading of a microscope slide 1000 with a specimen 2000 covered by a cover glass 300;

FIG. 3A is an illustration of “ringing” by wipe;

FIG. 3B is an illustration of ringing by dropper;

FIG. 4 is an image of ethyl centralite; and,

FIG. 5 is a process flow diagram for preparing a ringing sealant according to this disclosure.

In the drawings, the following reference numerals are associated with the following exemplary and non-limiting components:
1000—microscope slide;
2000—specimen;
3000—cover glass; and,
4000—ringing sealant.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

Disclosed is a ringing sealant defined by the addition of ethyl centralite to a solution of partially nitrated cellulose or cellulose nitrate dissolved in acetone. Suitably, the preferred embodiment of the ringing sealant for microscope slides features a degree of elasticity sufficient to prevent that mixture from cracking a cover glass as the mixture dries or when dried.

More specifically, the disclosed ringing sealant is a cellulose nitrate lacquer made with an acetone solvent base plus an additive of ethyl centralite. In a preferred embodiment, the cellulose nitrate lacquer includes cellulose nitrate with a nitration level preferably between 10.7% and 12.3%. Although a range of 10.7 to 12.3% is preferred, it should be understood that a cellulose nitrate with a nitration level as low as 10% or as high as 14% may be used without departing from the spirit and intent of the invention.

FIG. 4 is an image of ethyl centralite. Ethyl centralite is a symmetrical derivative of urea that is insoluble in water, but soluble in acetone, ethanol, and benzene. Until now, known uses of ethyl centralite include use as a burning-rate modifier, stabilizer for black powder, and plasticizer for celluloid. Synonyms for ethyl centralite include “CENTRALITE NUMBER 1,” “CENTRALITE,” or “1,3-diethyl-1,3-diphenylurea.” The empirical formula for ethyl centralite is C₁₇H₂ON₂O. The CAS No. of ethyl centralite is 85-98-3, U.N. No. 2811.

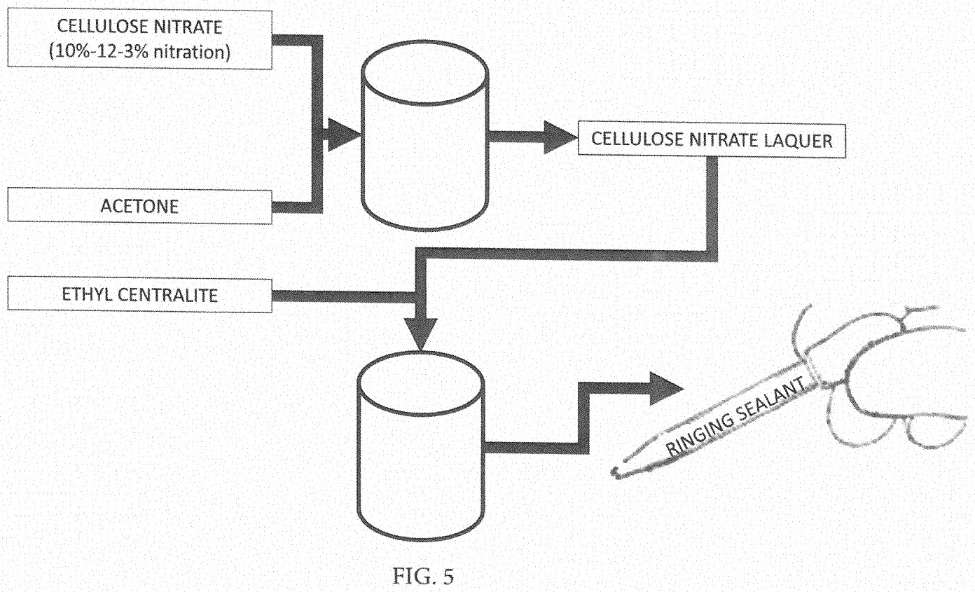

FIG. 5 is a process flow diagram for manufacturing a preferred ringing sealant. Referring to FIG. 5, in one mode of manufacture, the disclosed cellulose nitrate may be dissolved in acetone in a convenient proportion to create a solution of the desired consistency for use as a ringing sealant for microscope slides. Added to this solution is ethyl centralite in an amount preferably equal to 1% by weight of the combined mixture of cellulose nitrate, acetone and ethyl centralite. Although, it should be understood that concentrations in excess of 10% ethyl centralite to the weight of the resulting solution may be used. An increase in the concentration of ethyl centralite above 1% by weight does not necessarily add any greater benefit to the resulting mixture, however, concentrations in excess of 10% of ethyl centralite to the weight of the resulting mixture may result in a decrease in the adhesion of the mixture to glass occurs. It should be understood that in place of acetone, other keytones such as methyl ethyl ketone or methyl isobutyl ketone may be used. Such keytones also be used in combination with other solvents such as some esters, glycol ethers or A-grade methanol or A-grade ethanol or these may also be used in combination with lower grade alcohols or diethyl ether.

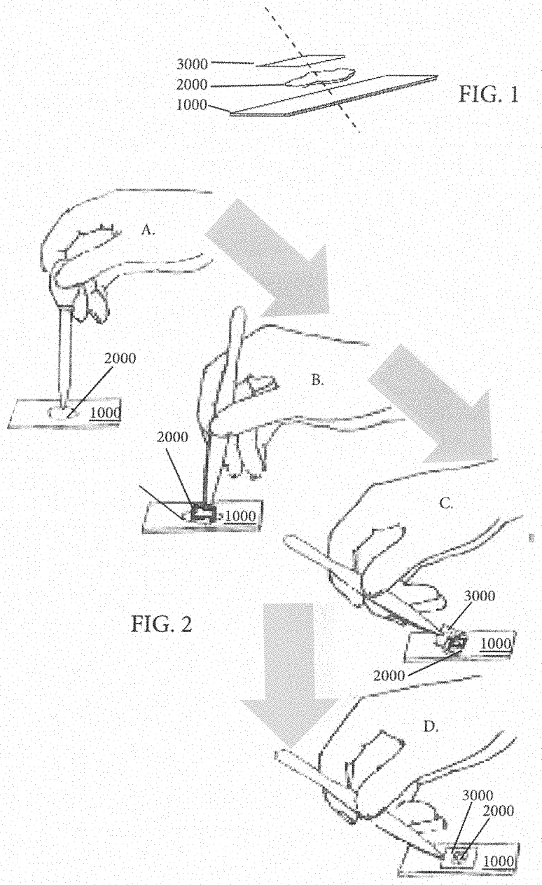

FIGS. 1 through 3B illustrate a preferred mode of use of the disclosed ringing sealant. As shown in FIGS. 1 and 2, a specimen 2000 is mounted on a microscope slide 1000 using any of the usual methods know in the art wherein a specimen 2000 is positioned on a microscope slide 1000 and a cover glass 3000 with a face or footprint of a width or diameter less than or equal to the width of the support surface of the microscope slide 1000 is then placed on top of the specimen 2000.

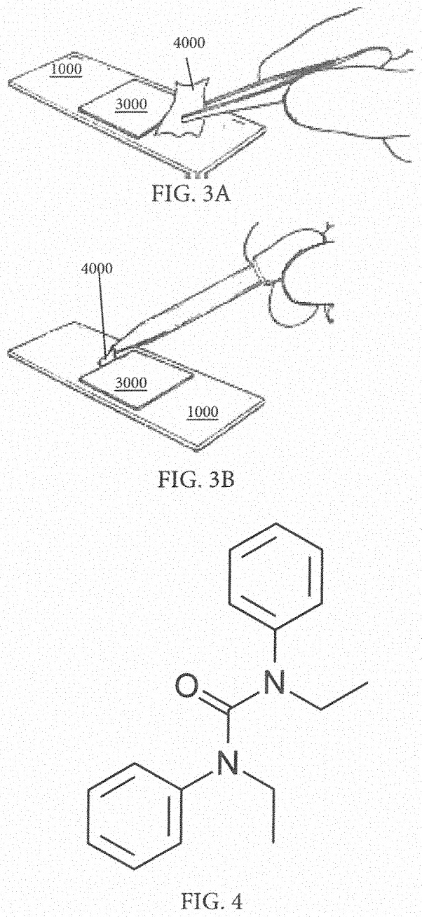

Referring now to FIGS. 3A and 3B, a mixture of acetone, cellulose nitrate and ethyl centralite 4000 is prepared as described above and suitably applied to the gap or space between the cover glass 3000 and the microscope slide 1000. As shown, the ringing sealant may be applied by dropper or wipe and then allowed to dry at ambient temperature, atmospheric pressure and humidity. Alternately, it can be caused to dry by various laboratory drying arrangements used to speed drying. The disclosed ringing sealant mixture is suitably transparent to visible light and of a viscosity low enough to flow into the space between the cover glass and the microscope slide. Additionally, the disclosed ringing sealant suitably has a capillarity that is high enough for the sealant to be drawn into this gap or space by capillary action under normal laboratory conditions.

Suitably, the ringing sealant as described above, upon drying quickly and completely, bonds to the cover glass and to the underlying microscope slide. In this manner, the cover glass may be immobilized relative to the mounted specimen and the underlying microscope slide. Thus, a solid moisture-proof barrier is formed between the specimen or the medium in which the specimen is mounted and the external environment, while retaining sufficient elasticity so as not to crack the cover glass.

Preferred Embodiment—EXAMPLE 1.

In a preferred exemplary and non-limiting embodiment, one part by weight of dry cellulose nitrate with a nitration level of twelve (12%) percent by weight is dissolved in twenty (20) parts by weight of acetone and thoroughly blended by any conventional means and filtered by any conventional means. In this instance, it is filtered through glass wool in order to obtain a clear and homogenous liquid from which a portion equaling one-hundred fifty-four (154) grams is taken and to this portion is added and dissolved three (3) grams of ethyl centralite as a plasticizing agent to produce a plasticized cellulosic lacquer.

Once produced, a microscope slide mounting a specimen sample is prepared by means known in the art such that this mounting includes a base microscope slide made of glass and a specimen of some biological matter placed on the slide. Suitably, the specimen may be affixed to the slide by any of the usual means of mounting a specimen on a microscope slide such that the specimen is a thin portion of biological matter and as such is of a thickness proportionately less than that of the microscope slide on which it is mounted. Suitably, applied to and above this specimen is a clear glass coverslip such that the mounted specimen is between the coverslip and the microscope slide. Preferably, the least horizontal measurement of the coverslip is greater than the corresponding measurement of the specimen and less than the corresponding measurement of the microscope slide. The microscope slide and mounted specimen so assembled are allowed to dry and cure in the manner appropriate to its components and preparation as is known in the art.

Preferably, the disclosed plasticized cellulosic lacquer produced as described above is applied to the mounted loaded microscope slide in such a manner that the lacquer as applied is in contact with both the coverslip and the microscope slide throughout the length of all slides of the coverslip so as to make a continuous seal of the vertical space between the coverslip and the microscope slide and thereby creates a barrier to the ingress of moisture into the space between the cover slip and the microscope slide.

Preferred Embodiment EXAMPLE 2.

In another preferred exemplary and non-limiting embodiment, the ringing sealant is a cellulosic lacquer prepared by any conventional means and to this lacquer is added methyl acetate in an amount consistent with the use of the resulting mixture as a sealant for microscope slides. To said mixture is added and dissolved one (1) percent by weight of ethyl centralite to produce a plasticized cellulose lacquer which may then be used to seal the space between the edges of the coverslip and the underlying microscope slide of mounted microscope slides as described above.

Preferred Embodiment EXAMPLE 3.

In another preferred exemplary and non-limiting embodiment a cellulosic lacquer is prepared by any conventional means and to this lacquer is added butyl acetate, touleen, methyl ethyl ketone, cellulose ester, butanol, methyl isobutyl ketone, isopropanol, xylene, ethanol, ethylbenzene, and dimethyl heptanone in proportions sufficient to achieve the desired reflective surface characteristics and non-yellowing qualities in the lacquer so produced and to this mixture is added and dissolved eight (8) percent by weight of ethyl centralite to produce a plasticized cellulose lacquer which may then be used to seal the space between the edges of the coverslip and the underlying microscope slide of mounted microscope slides as described above.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A process of preparing a microscope slide ringing sealant comprising the steps of:
dissolving ethyl centralite in a proportion equal to about 1% of the total weight of the resulting mixture in a solution of cellulose nitrate.

2. The process of claim 1 wherein the cellulose nitrate has a nitration level in a range of 10.7% to 12.3% by weight dissolved in acetone.

3. The microscope slide ringing sealant prepared according to claim 1.

4. A ringing sealant for microscope slides, said sealant comprising:
a cellulose nitrate lacquer made with an acetone solvent base plus an additive of ethyl centralite.

5. The ringing sealant for microscope slides of claim 4, wherein the cellulose nitrate lacquer includes cellulose nitrate with a nitration level preferably in a range of 10.7% to 12.3%.

6. The ringing sealant for microscope slides of claim 4, wherein the cellulose nitrate lacquer includes cellulose nitrate with a nitration level preferably in a range of 10 to 14%.

7. A kit comprising the ringing sealant of claim 4, a microscope slide, and a cover glass.

8. A method of preparing a microscope slide comprising the steps of:
placing a specimen on a surface of the microscope slide;
placing a cover glass on the specimen; and,
applying a ringing sealant around the specimen and along a periphery of the cover glass so that a gap between the surface of the microscope slide and the cover glass is filled by the ringing sealant,
allowing the ringing sealant to dry; and,
wherein the ringing sealing comprises a cellulose nitrate lacquer made with an acetone solvent base plus an additive of ethyl centralite.

9. The method of claim 8 wherein the cellulose nitrate lacquer includes cellulose nitrate with a nitration level in a range of 10.7% to 12.3%.

10. The method of claim 8 wherein the cellulose nitrate lacquer includes cellulose nitrate with a nitration level in a range of 10 to 14%.
